(19) United States
(12) Patent Application Publication
(10) Pub. No.: US 2010/0253013 A1
(43) Pub. Date: Oct. 7, 2010

(54) Co-Extruded Reinforced Sealing Strip for a Motor Vehicle or Building, Its Manufacturing Method and Device.

(75) Inventor: Morgan Mills, Madbury, NH (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Hutchinson Sealing Systems

(21) Appl. No.: 12/749,725

(22) Filed: Mar. 30, 2010

Related U.S. Application Data
(60) Provisional application No. 61/166,038, filed on Apr. 2, 2009.

(51) Int. Cl. F16J 15/10; B29C 47/02; F16J 15/02

(52) U.S. Cl. 277/647; 264/279.1; 425/113; 277/651

(57) ABSTRACT

The present invention relates to a co-extruded sealing strip for a motor vehicle or building which is reinforced by at least one plastic carrier, to a method for manufacturing such a strip and to a device for implementing this method.

This sealing strip includes at least one extruded reinforcing plastic carrier around which a flexible polymeric cover is co-extruded and which forms at least one continuous line having undulations extending lengthwise with a variable pattern, such as a variable undulations period, so as to locally impart a variable flexibility or compressibility thereto.

The method for manufacturing this strip in particular includes:
a) extruding a carrier blank in the shape of at least one two-dimensional undulated line through an oscillating die plate which reciprocates in a direction perpendicular to the extrusion direction and according to a reciprocating speed which varies in relation to the extrusion speed, so that the undulations pattern of the carrier blank varies along the length thereof,
b) co-extruding the cover around this carrier blank,
c) calibrating the obtained co-extruded strip blank to give it its desired three-dimensional configuration, and
d) cooling the strip so that it keeps its final configuration.

### CROSS REFERENCE TO RELATED APPLICATIONS

This application is related to commonly owned copending Provisional Application Ser. No. 61/166,038, filed Apr. 2, 2009, incorporated herein by reference in its entirety, and claims the benefit of its earlier filing date under 35 U.S.C. 119(e).

The present invention relates to a co-extruded sealing strip for a motor vehicle or building which is reinforced by at least one plastic carrier, to a method for manufacturing such a strip and also to a device for implementing this method. The invention particularly concerns motor vehicle sealing strips reinforced with such a carrier, which may form either glass run channels, door seals or inner or outer belts, for instance.

### BACKGROUND OF THE INVENTION

Existing methods for manufacturing reinforced sealing strips may generally be divided into two families, one of which consists in extruding a thermoset or thermoplastic material onto and around a stamped metal U-shaped carrier, the other one consisting in co-extruding an elastomeric cover—such as a thermoplastic elastomer (TPE)—onto an extruded plastic carrier which has a solid U-shaped cross-section along its length. FIG. 1 shows such a constant and continuous cross-section for the carrier 1, which is obtained by extrusion through a die with a continuous flow of material.

This first manufacturing method usually allows to obtain sealing strips exhibiting a satisfactory flexibility or compressibility, thanks to the incorporation of the stamped carrier. Nevertheless, a major drawback of such methods resides in the sum of operations required, in particular due to the coil stands, roll formers and the associated tools and equipment to shape the metal (e.g. steel) before it enters the extruder. As a result, the manufacturing cost of such a metal-reinforced strip is relatively high.

This second manufacturing method using a solid plastic carrier, while remedying this drawback due to the single inline operation that characterizes co-extrusion, does not allow to obtain sealing strips which are flexible enough so as to be sufficiently curved locally to precisely follow low radii of curvature.

European Patent EP-B1-1 093 902 teaches to manufacture a curveable plastic reinforcing carrier for a sealing strip presenting a pattern comprising solid portions and open portions in the dorsal region, by extruding a bead or preform of thermoplastic material and calendering this bead or preform to impart said pattern thereto in such as manner as to leave, in the open portions of the dorsal region, web regions that are thin relative to the solid portions and that form bridges between these solid portions.

European Patent EP-B1-0 955 148 discloses an extruded strip incorporating a metal/plastic composite carrier, which has an undulated wire core in a continuous serpentine manner, said strip having an elastomeric cover with a selectively positioned high temperature thread for instance in polyamide which extends longitudinally through the cover to thereby select the neutral bending axis of the strip.

A major drawback of the sealing strips presented in these patents resides in the relative complexity of their manufacturing method and, as a consequence, in their relative expensive manufacturing cost.

### OBJECTS AND SUMMARY OF THE INVENTION

It is an object of the present invention to provide an extruded sealing strip for a motor vehicle or building designed to be clamped upon a frame, said strip comprising at least one extruded reinforcing plastic carrier around which a flexible polymeric cover is co-extruded, which remedies the aforementioned drawbacks and in particular combines the flexibility of the above-mentioned first family of strips with stamped metal carriers with the single inline operation characterizing the manufacturing method of the second family of strips using extruded solid plastic carriers.

For this purpose, a sealing strip according to the invention is such that said at least one carrier forms at least one continuous line having undulations which extend lengthwise and which have a variable pattern along the length of said strip so as to locally impart a variable flexibility or compressibility thereto.

By “line”, it is meant in instant description a continuous and thin elongated extruded element, such as a plastic wire, be it of either circular, elliptic or even flat cross-section like a plastic strip or band or polygonal cross-section (e.g. rectangular).

It is to be noted that this undulated (i.e. like a continuous serpentine with alternate peaks on either sides) shape of said at least one line which is included in the or each carrier according to the invention provides not only an improved flexibility for the overall co-extruded strip over its length, since it is not in a continuous solid shape from one end to another, but also a flexibility or compressibility that varies locally between both ends. This variation of the strip flexibility or compressibility is such that the undulated line(s) of the or each carrier make the strip relatively rigid in one or several determined portion(s) thereof (over the length of the strip) which are for instance designed to be tightly clamped on a straight portion of the frame, and more flexible or compressible in other determined portions of the strip which may be designed to be curved with specific bend radii to follow corresponding radii of curvature of the frame or to improve the acoustic performance of the strip at these more compressible locations.

It will also be noted that these undulations may extend over the entire length of the corresponding line or only over the major part thereof, and that such undulations may be in the form or curved and/or pecked lines.

According to another feature of the invention, said undulations may form at least one rigid zone and several adjacent flexible or compressible zones in said strip and are defined by a period or step, measured lengthwise, which varies along said strip from a lower value in said at least one rigid zone to a greater value in each of said flexible or compressible zones.

According to still another feature of the invention, said at least one rigid zone may be substantially straight, being able to be tightly clamped upon a corresponding straight portion of said frame, whereas each of said flexible or compressible zones may be able to follow a determined radius of curvature of a corresponding curved portion of said frame.

Advantageously, said at least one carrier may have a substantially U, C, V, S or W-shaped cross-section and comprises two lateral arms extending from a base which are designed to be clamped upon the frame, said undulations extending alternately from one lateral arm to the other one.

According to an embodiment of the invention, said at least one plastic carrier may then be formed by one undulated line which has two lateral series of end peaks respectively extending along said arms in alternation.

According to a variant embodiment of the invention, said at least one plastic carrier may be formed by at least two simultaneously co-extruded undulated lines which are joined together, so that said strip has a neutral bending axis whose position varies along it from a central position in the median plane of said base to an off center position adjacent one of said arms, this off center position being in particular designed to assist the curvature of at least one of said flexible zones of said strip towards the outside of this adjacent arm. In this variant embodiment, said at least one plastic carrier may advantageously be formed by two substantially identical undulated lines which have each a lateral series of peaks along one of said arms and a central series of peaks along said base, the central series of peaks of both lines being joined together in a junction along said base:

either peak to peak to form in this junction said neutral bending axis, both lines forming in a top view a succession of rhombs or hexagons, for example,

or in such a way that the peaks of both central series respectively overlap each other so as to form for example a succession of stretched figures along said base, which are interspersed in alternation with another succession of lanced figures respectively formed by the pairs of facing peaks of both lateral series.

In this variant embodiment, these figures may for instance be rhombs or hexagons having more or less round summits.

It will be noted that in these embodiments, the above-referred peaks may be either acute or flat.

According to a further variant embodiment of the invention, said at least one plastic carrier may be formed by one undulated line to which is joined at least one straight line extending along the longitudinal direction of said base.

Preferably, said at least one plastic carrier is based on at least one extrusible thermoplastic polymer, such as a polypropylene, said flexible polymeric cover being based on at least one co-extrusible elastomer, more preferably a thermoplastic elastomer (TPE).

According to another aspect of the invention, said sealing strip may advantageously form a glass run channel for a side window designed to be mounted on a door frame, or a door seal designed to be mounted on a bodywork of the motor vehicle, with in both cases several substantially straight rigid portions and several more flexible curved portions extending over the length of the strip.

Alternatively, said sealing strip may form an inner belt for a side window comprising said two compressible zones at both ends of said rigid zone, both compressible zones improving the acoustic performance of the inner belt.

A method according to the invention for manufacturing an extruded sealing strip for a motor vehicle or building designed to be clamped upon a frame, said strip comprising at least one extruded reinforcing plastic carrier around which a flexible polymeric cover is co-extruded, comprises:

a) extruding a blank for said at least one carrier in the shape of at least one two-dimensional undulated line which has alternating undulations extending in an extrusion direction, through at least one oscillating die plate which reciprocates back and forth in a direction perpendicular to said extrusion direction and according to a reciprocating speed which varies at given time intervals in relation to the linear extrusion speed, in such a manner that the undulations pattern of said at least one extruded carrier blank varies along the length thereof,

b) co-extruding said cover which is preferably based on at least one co-extrusible thermoplastic elastomer (TPE), either simultaneously or subsequently onto and around said at least one extruded carrier blank, so as to obtain a co-extruded strip blank,

c) calibrating this co-extruded strip blank in calibrating or sizing plates or blocks, so as to give it its desired final three-dimensional configuration, such as in a substantially U, C, V, S or W-shaped cross-section, and

d) cooling the strip obtained in step c) so that it keeps its final configuration, the undulations pattern created in step a) imparting more or less flexibility to the sealing strip along its length.

It is to be noted that the use of an oscillating die plate in step a) allows to obtain many variations for the shape of the or each carrier, by varying speeds and dwells of the extrusion equipment. The cross-section chosen for the or each carrier combined with the reciprocating speed of the die plate and with the linear travel speed of the plastic material through it determine, by these variations of the undulations pattern, the local flexibility or compressibility of this carrier.

According to another feature of this inventive method, step a) may comprise varying said reciprocating speed in relation to said linear extrusion speed in such a manner that said undulations form at least one rigid zone and several adjacent flexible or compressible zones in said strip, and are defined by a period, measured lengthwise, which varies along said strip from a lower value in said at least one rigid zone to a greater value in each of said flexible or compressible zones.

This undulations period which varies over the length of the or each carrier is thus chosen very low (i.e. with a high frequency for the undulations) in the zones of the sealing strip designed to be very rigid for a satisfactory mounting upon the frame, whereas this period is chosen higher (i.e. with a lower frequency) to impart more flexibility or compressibility to the strip due to a locally increased spacing between consecutive undulations. As way of example, a thinner cross-section, a slower reciprocating speed and a higher linear travel speed will produce such more flexible or compressible zones over the length of the strip.

Advantageously, said at least one rigid zone formed in step a) may be substantially straight, whereas each of said flexible or compressible zones also formed in step a) may be curveable in step c) according to a determined radius of curvature of a corresponding curved portion of said frame.

It should be noted that this inventive method allows to do without any additional bending or heat forming operation for curving theses portions thanks to this variable undulations pattern, which saves further manufacturing steps and thus leads to a reduced global cost for the sealing strip.

According to different embodiments of the invention, said at least one carrier blank obtained in step a) may be formed by:

one undulated line which has two lateral series of end peaks respectively extending lengthwise in alternation, or by

at least two undulated lines which are simultaneously co-extruded and joined together, so that said strip obtained in step d) has a neutral bending axis whose position varies along it from a central position in the median plane of said blank to an off center position with respect to that median plane, this off center position assisting the curvature of at least one curved flexible zone towards the adjacent lateral end of the strip.

Advantageously, step a) may be carried out by means of programmable stepper motors, to make said at least one die plate oscillate according to a reciprocating speed which is controlled with respect to said variable linear extrusion speed.

Preferably, step b) is carried out by means of at least one additional extrusion die for the subsequent co-extrusion of said flexible cover.

A device according to the invention for manufacturing an extruded sealing strip for a motor vehicle designed to be clamped upon a frame, said strip comprising at least one extruded reinforcing plastic carrier around which a flexible polymeric cover is co-extruded, comprises:

a co-extrusion unit for co-extruding said cover onto and around said at least one carrier, which is in the shape of at least one two-dimensional undulated line which has undulations extending in an extrusion direction, said co-extrusion unit comprising:

at least one oscillating die plate which is designed to extrude said at least one carrier and which is able to reciprocate back and forth in a direction perpendicular to said extrusion direction, so as to form said undulations with a pattern which varies along the length of said carrier, preferably with a varying period of undulations,

control means, which preferably comprise programmable stepper motors, and which are designed to make said at least one die plate oscillate according to a controlled reciprocating speed which is variable with respect to an also controlled linear extrusion speed for said at least one carrier, and

at least one additional extrusion die for the co-extrusion of said cover onto and around said a least one carrier so as to obtain a two-dimensional sealing strip blank;

calibration or sizing plates or blocks for calibrating the co-extruded strip blank, to give it its desired final three-dimensional configuration, such as in a substantially U, C, V, S or W-shaped cross-section; and

cooling means for cooling the calibrated strip so that it keeps its final configuration.

It should be noted again that this inventive device allows to do without the additional equipment and tooling required for manufacturing sealing strips with stamped metal carriers.

### BRIEF DESCRIPTION OF THE DRAWINGS

Other advantages, characteristics, and details of the invention appear from the following additional description with reference to the accompanying drawings, given purely by way of example, and in which:

FIG. 1 is a perspective view of an example of extruded plastic solid carrier for a sealing strip according to the prior art;

FIG. 2 is a cross-sectional view of an exemplary three-dimensional U-shaped sealing strip according to the invention once co-extruded and calibrated;

FIG. 3 is a cross-sectional view of a two-dimensional co-extruded strip blank according to the invention which is designed to form the sealing strip of FIG. 2 after being calibrated;

FIG. 4 is a perspective view of a door seal for a motor vehicle side door forming a sealing strip according to a preferred way of implementation of the invention;

FIG. 5 is a front view of an inner belt for a motor vehicle side door forming a sealing strip according to a variant way of implementation of the invention;

FIGS. 6 and 7 are two similar perspective views of an inventive U-shaped carrier whose undulations define a two joined lines pattern with a variable period according to an embodiment of the invention, FIG. 7 showing in transparency the undulations of the same carrier on the lateral side hidden in FIG. 6;

FIG. 8 is a diagrammatic top view of a two-dimensional extruded carrier blank having two undulated lines which are joined together with a constant period of undulations and which are designed to form the undulations pattern of FIGS. 6 and 7 after a three-dimensional shaping;

FIG. 9 is a two-dimensional computer modeling of an extruded carrier blank substantially according to FIG. 8, but showing a variable undulations period over the length thereof;

FIG. 10 is a two-dimensional computer modeling of an extruded carrier blank substantially according to FIG. 9, but showing a variable location of the neutral bending axis of the carrier due to an off center position of the junction between both undulated lines compared to FIG. 9;

FIG. 11 is a diagrammatic view showing an exemplary device of the invention for manufacturing an inventive sealing strip, also showing in both top and cross-sectional views the extruded carrier blank and the corresponding sealing strip obtained according to a variant embodiment of the invention;

FIG. 12 is a perspective view showing the undulated shape of a three-dimensional extruded carrier according to the embodiment of FIG. 11, the single undulated line being showed with a constant period;

FIG. 13 is a partial top view of the carrier of FIG. 12;

FIG. 14 is a partial side view of the carrier of FIG. 12;

FIG. 15 is a cross-sectional view along plane XV-XV of FIG. 14 of the same carrier of FIG. 12;

FIG. 16 is a two-dimensional computer modeling in a perspective view of an extruded carrier blank substantially according to FIGS. 11 to 15;

FIG. 17 is a diagrammatic top view of the two-dimensional extruded carrier blank with a single undulated line according to FIG. 16;

FIG. 18 is a diagrammatic top view of a two-dimensional extruded carrier blank according to a variant embodiment of FIG. 17;

FIG. 19 is a diagrammatic top view of a two-dimensional extruded carrier blank according to a variant embodiment of FIG. 18;

FIG. 20 is a diagrammatic top view of a two-dimensional extruded carrier blank according to another variant embodiment of FIG. 18;

FIG. 21 is a diagrammatic top view of a two-dimensional extruded carrier blank according to a variant embodiment of FIG. 17, showing one undulated line joined to two straight lines;

FIG. 22 is a diagrammatic top view of a two-dimensional extruded carrier blank according to a variant embodiment of FIG. 8, showing two joined undulated lines each according to FIG. 17 defining a neutral bending axis in the longitudinal median plane of the shaped strip;

FIG. 23 is a diagrammatic top view of a two-dimensional extruded carrier blank according to a variant embodiment of FIG. 22, showing an off center position for this neutral bending axis; and

FIG. 24 is a two-dimensional computer modeling in a perspective view of an extruded carrier blank substantially according to FIG. 22.

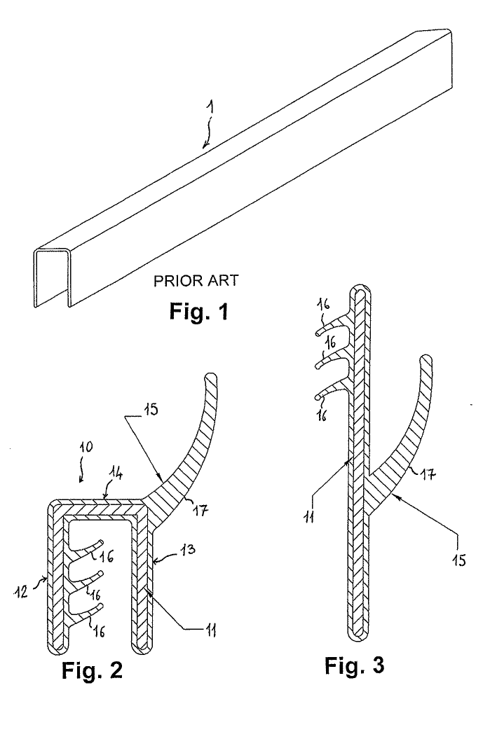

### MORE DETAILED DESCRIPTION

As visible in FIGS. 2 and 3, a co-extruded sealing strip 10 according to the invention comprises:

at least one extruded reinforcing plastic carrier 11, for instance made of polypropylene, which is finally U-shaped with two lateral arms 12 and 13 extending from a base 14 and designed to be clamped upon a motor vehicle frame (e.g. on the bodywork thereof or on a door frame), and

a flexible polymeric cover 15, preferably based on a thermoplastic vulcanizate (TPV) such as Vegaprene®, Santoprene® or Sarlink®, which is co-extruded onto and around the carrier 11 so as to enclose it and which also forms sealing lips 16 at least on the inner face of one arm 12 for mounting on the frame and a main outer sealing lip 17 at the junction of the base 14 and the outer face of the other arm 13.

This final U-shape for the carrier 11 is obtained after calibration of the two-dimensional strip blank visible in FIG. 3. It will be noted that FIGS. 2 and 3 are merely exemplary embodiments among a great variety of possible shapes for the sealing strips of the invention, which may exhibit very different cross-sections provided that their respective carriers present the following features.

According to the invention, the inventive sealing strip 10 has several separate zones over its length which are more or less flexible or compressible because of different determined local shapes of the co-extruded carrier 11. As will be explained below in relation to FIGS. 6 to 24, the carrier 11 forms at least one continuous line having undulations which extend lengthwise and which have a variable pattern along the length of the strip 10 so as to locally impart a variable flexibility or compressibility thereto.

In the embodiment of FIG. 4 relating to a door seal 18, these undulations of the carrier 11 form several substantially straight rigid zones 19 to 24 and several curved flexible zones 25 to 30, which radii behaviour is improved thanks to a specific undulations pattern, as detailed below.

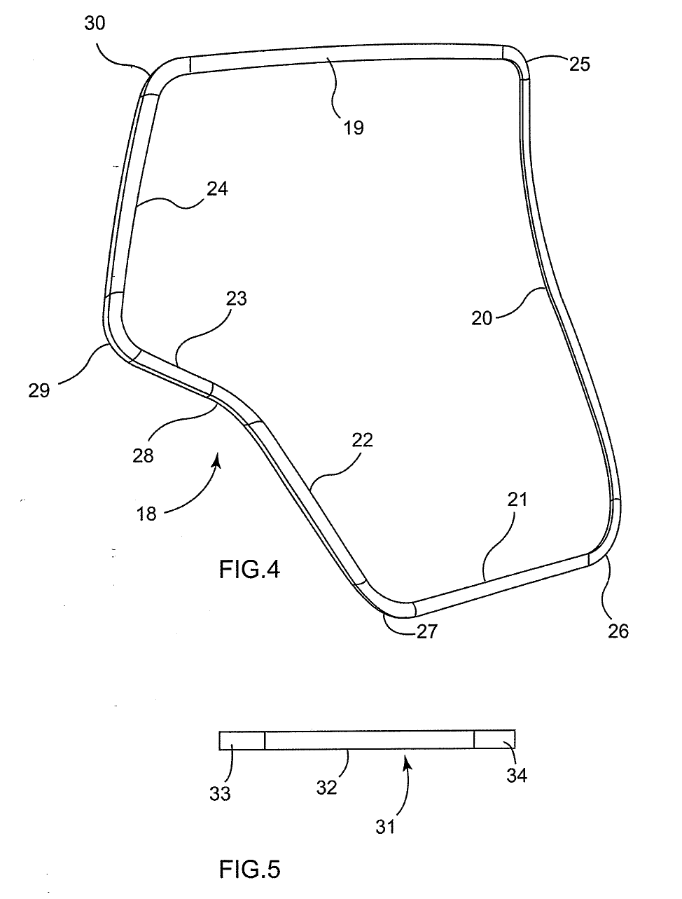

In the embodiment of FIG. 5 relating to an inner belt 31, these undulations of the carrier 11 form one straight rigid zone 32 and two adjacent compressible end zones 33 and 34, which allow to improve the acoustic performance of the vehicle.

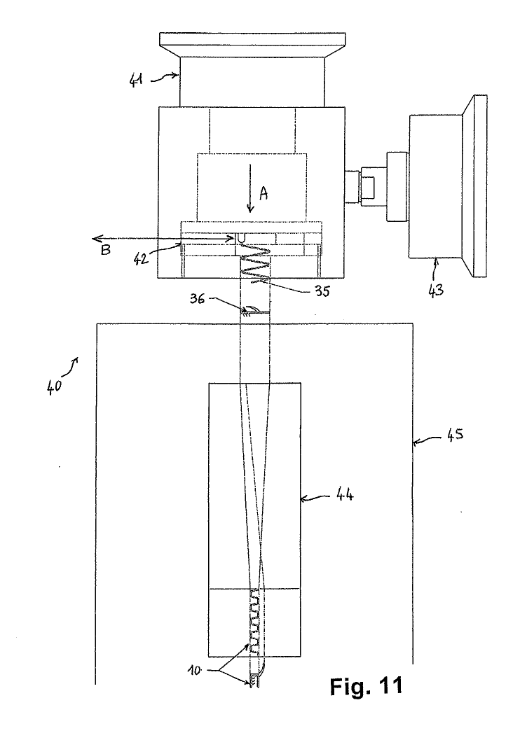

As visible in FIG. 11, a device 40 according to an exemplary embodiment of the invention for manufacturing the strip 10 comprises:

a co-extrusion unit 41 for co-extruding the cover 15 onto and around the carrier 11 in the shape of at least one two-dimensional undulated line 35 in the extrusion direction A, this unit 41 comprising:

at least one oscillating die plate 42 which is designed to extrude the carrier 11 and which is able to reciprocate back and forth in a direction B perpendicular to the extrusion direction A, so as to form at least one line 35 (visible in top view in FIG. 11 beneath the die plate 42) with a pattern which varies along the length of the carrier 11 with a varying period or step of undulations,

control means (not visible) which may comprise programmable stepper motors to make the at least one die plate 42 oscillate with a controlled speed which is variable with respect to the also controlled linear extrusion speed for the carrier 11, and

at least one additional extrusion die 43 for the co-extrusion of the cover 15 onto the carrier 11 so as to obtain a two-dimensional sealing strip blank 36 (visible in cross-section in FIG. 11 beneath the undulated line 35);

calibration or sizing plates or blocks 44 for calibrating the co-extruded blank 36, to obtain the sealing strip 10 with its desired three-dimensional configuration (visible in top view and in cross-section at the bottom of FIG. 11); and

a conventional cooling unit 45 for cooling the calibrated strip so that it retains its final configuration.

The extrusion of the carrier 11 is carried out through the at least one oscillating die plate 42 reciprocating in direction B with a reciprocating speed which varies at given time intervals in relation to the linear extrusion speed, in such a manner that the undulations pattern of the carrier blank 35 varies along the length thereof.

The co-extrusion of the cover 15 may be carried out either simultaneously or subsequently onto the at least one extruded carrier blank 35, so as to obtain the co-extruded strip blank 36.

FIGS. 6 to 10 show a preferred exemplary embodiment of an undulated carrier 111 of the invention, which is obtained by simultaneously co-extruding and joining together two lines or wires 111a and 111b each having alternating identical or similar peaks (i.e. with substantially the same amplitude) designed to extend alternately from one lateral arm 12 to the other arm 13 of the finally U-shaped sealing strip 10 (see again FIG. 2).

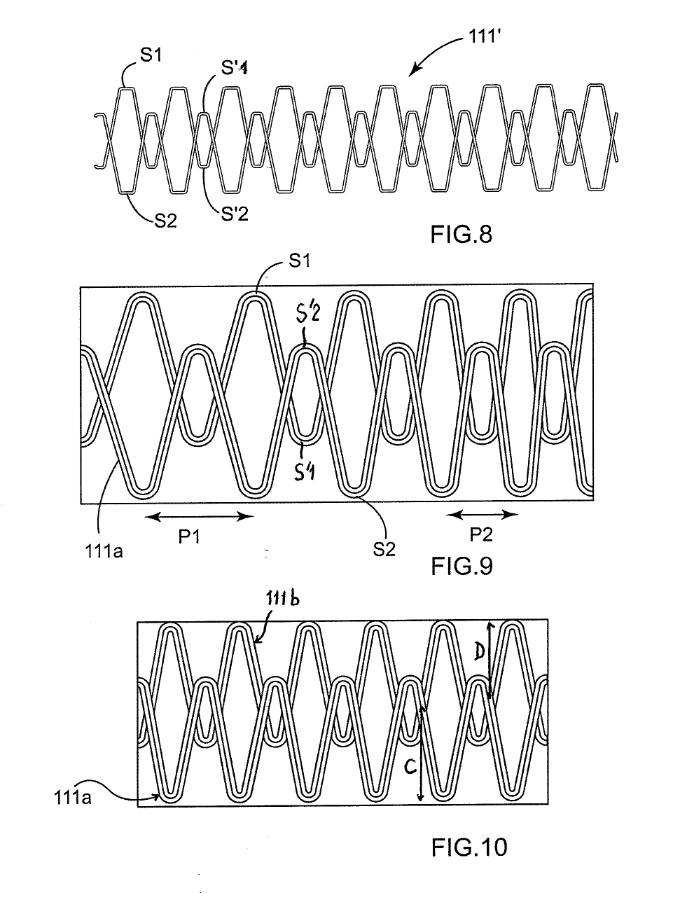

Both lines 111a and 111b each have a lateral series S1, S2 of peaks designed to extend along one arm 12, 13 and a central series S′1, S′2 of peaks along the base 14, the central series S′1, S′2 of both lines being joined together in a junction along the base 14 so that the peaks of both central series S′1, S′2 respectively overlap each other to form a succession of stretched figures (e.g. small rounded rhombs in FIGS. 6, 7, 9, 10 or hexagons for the carrier 111′ of FIG. 8) along the base 14, which are interspersed in alternation with another succession of lanced figures (e.g. big rhombs or hexagons respectively formed by the pairs of facing peaks of both lateral series S1 and S2).

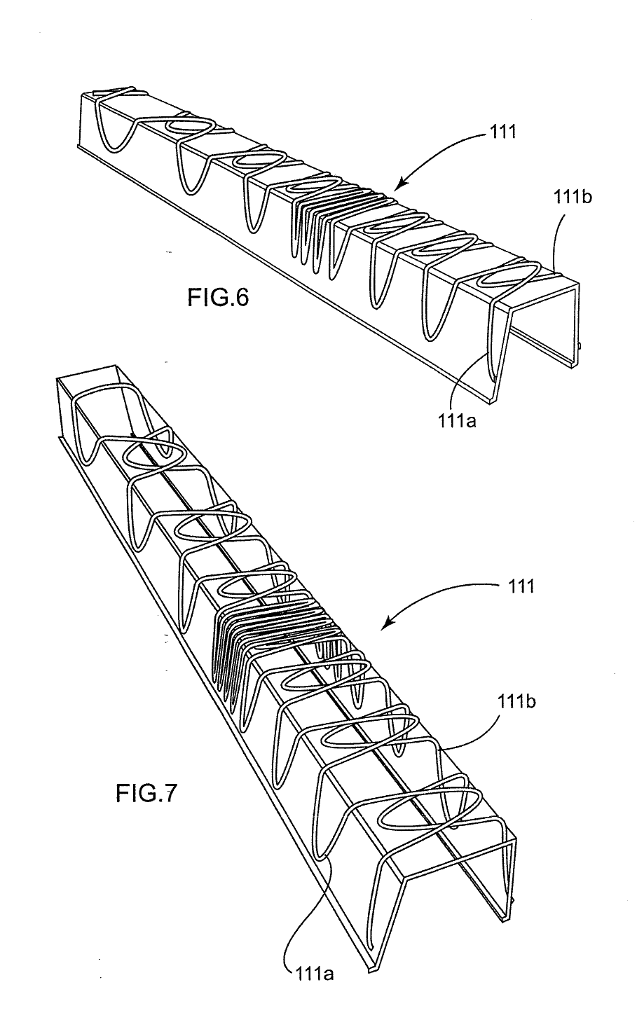

As visible in FIGS. 6 and 7, when the reciprocating speed of the oscillating die plate 42 is increased in relation to the linear extrusion speed, then the undulations frequency is also increased which makes rigid zones with very dense undulations and extremely close peaks (such as the zones 19-24 or 32 in FIGS. 4 et 5). But when this reciprocating speed is decreased for the same extrusion speed, then the undulations frequency decreases which makes more flexible or compressible zones with more distant peaks (such as the zones 25-30 and 33, 34 in FIGS. 4 and 5). Such a period for the undulations which varies along the longitudinal direction of the carrier 111 is also visible in the modeling of FIG. 9 (see both respective higher and lower values P1 and P2 for this period which continuously decreases from left to right).

As further visible in FIG. 10, this co-extrusion operation may advantageously locally displace the neutral bending axis of the carrier 111 from the central position of FIG. 9 to the off center position of FIG. 10 (i.e. adjacent to a lateral end of the carrier 111), in combination with the above-mentioned variable period of the undulations, to assist the curvature of each flexible zone of the finally shaped strip 10 towards the outside of the adjacent arm 12, 13 (see both arrows C and D in FIG. 10 showing the asymmetrical location of the neutral bending axis).

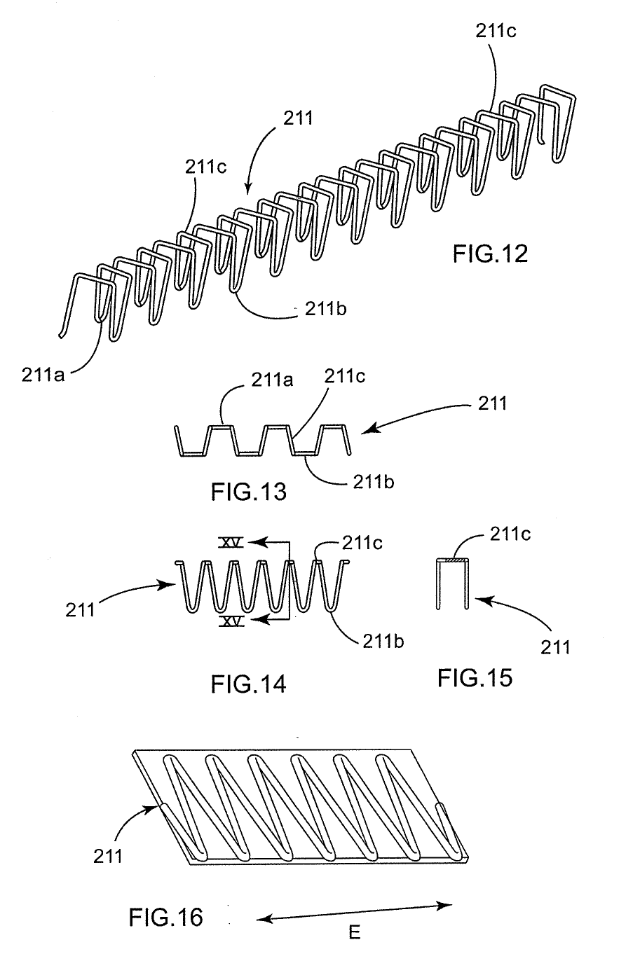

FIGS. 12 to 17 show another embodiment for an undulated carrier 211 of the invention, which is obtained by extruding a single line in a continuous serpentine manner, defining in the final U shape of FIG. 12 two lateral series of end peaks 211a, 211b respectively extending along the arms 12 and 13 in alternation. As visible in FIGS. 12 to 14, the U-shaped carrier 211 is made of these peaks 211a, 211b, which each end with a rounded point forming a return and which alternately extend along both arms 12 and 13, and of transverse linking portions 211c connecting together two consecutive peaks 211a and 211b along the base 14.

As visible by arrow E in FIG. 16, the undulations period of this carrier 211 of the invention is varied along the longitudinal direction thereof in such a manner that, when the reciprocating speed of the die plate 42 is increased in relation to the linear extrusion speed, rigid zones with dense undulations and close peaks 211a and 211b are obtained, whereas when the reciprocating speed is decreased for the same extrusion speed, more flexible or compressible zones with more distant peaks 211a and 211b are obtained.

The variant embodiments of FIGS. 18 and 19 only relate:

for FIG. 18, to an asymmetrical shape of the peaks 311a and 311b of both lateral sides for the carrier 311 (the peaks 311a on one side having an acute summit whereas those 311b on the other side have a flat one), and

for FIG. 19, to a symmetrical shape of the peaks 411a and 411b of both lateral sides for the carrier 411 (both peaks 411a and 411b having identical flat summits).

The carrier 511 according to the variant embodiment of FIG. 20 has an asymmetrical shape as that of FIG. 18, the peaks 511a on one side having an acute summit, but it differs from the latter in that the peaks of the other side have in alternation flat summits 511b and a couple of acute summits 511b′ connected together by a flat plate 511c.

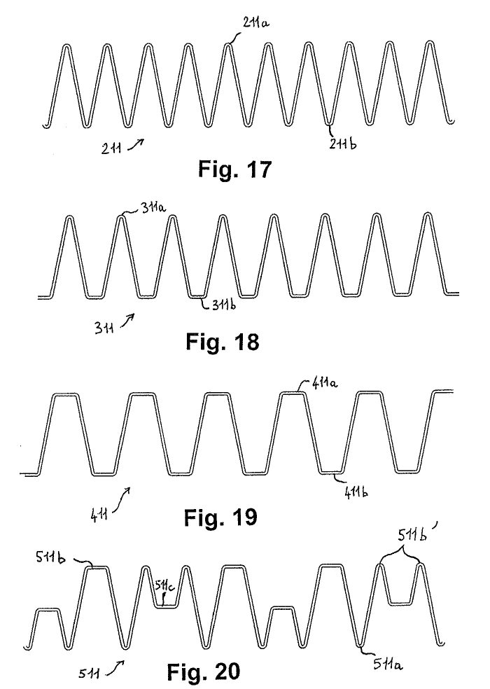

The carrier 611 according to the still variant embodiment of FIG. 21 differs from the preceding ones in that it is formed by only one undulated line 611a similar to that of FIG. 17, to which are joined two straight longitudinal lines 611b and 611c which are both designed to extend along the length of the base 14, so that this carrier 611 has a symmetrical shape with respect to the median longitudinal plane thereof.

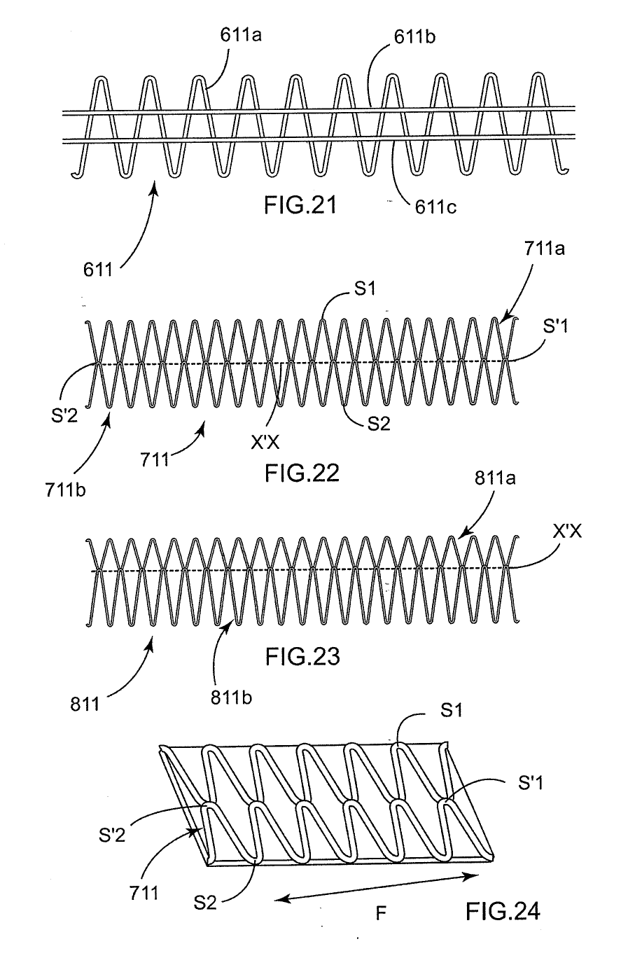

The carriers 711, 811 of FIGS. 22 to 24 represent variant embodiments to those of FIGS. 8 and 9.

The carrier 711 of FIGS. 22 and 24 is formed of two identical undulated lines 711a and 711b simultaneously co-extruded which have each a lateral series of peaks S1, S2 respectively designed to extend along either arms 12, 13 and a central series of peaks S′1, S′2 along the base 14, the central series S′1 and S′2 of both lines being joined together peak to peak in a centered junction along the base 14 to form in this junction a neutral bending axis X′X (visible in dotted lines) in the longitudinal median plane of the shaped strip 10. In these examples, both lines 711a and 711b may form in a top view a succession of rhombs (with round summits in the case of FIG. 24), the important thing to note being that the undulations period of both lines 711a and 711b is variable in the direction of arrow F.

The carrier 811 of FIG. 23 only differs from that of FIG. 22, in that both simultaneously co-extruded undulated lines 811a and 811b are joined together with a neutral bending axis X′X, whose position varies along it from the central one of FIG. 22 to an off center position designed to assist the curvature of the corresponding flexible zone of the strip 10 towards the outside of the arm 12 or 13 which is adjacent to this off center position.

While certain representative embodiments and details have been shown in FIGS. 6 to 24 for the purpose of illustrating the invention, it will be apparent to those skilled in this art that various changes and modifications may be made therein without departing from the spirit or scope of the invention.

What is claimed is:

1. Extruded sealing strip for a motor vehicle or building configured to be clamped upon a frame, said strip comprising at least one extruded reinforcing plastic carrier around which a flexible polymeric cover is co-extruded, wherein said at least one carrier forms at least one continuous line having undulations which extend lengthwise and which have a variable pattern along the length of said strip so as to locally impart a variable flexibility or compressibility thereto.

2. The sealing strip according to claim 1, wherein said undulations form at least one rigid zone and several adjacent flexible or compressible zones in said strip and are defined by a period, measured lengthwise, which varies along said strip from a lower value in said at least one rigid zone to a greater value in each of said flexible or compressible zones.

3. The sealing strip according to claim 2, wherein said at least one rigid zone is substantially straight, being able to be tightly clamped upon a corresponding straight portion of said frame, whereas each of said flexible or compressible zones is able to follow a determined radius of curvature of a corresponding curved portion of said frame.

4. The sealing strip according to claim 1, wherein said at least one carrier has a substantially U, C, V, S or W-shaped cross-section and comprises two lateral arms extending from a base which are configured to be clamped upon the frame, said undulations extending alternately from one lateral arm to the other one.

5. The sealing strip according to claim 4, wherein said at least one plastic carrier is formed by one undulated line which has two lateral series of end peaks respectively extending along said arms in alternation.

6. The sealing strip according to claim 4, wherein said undulations form at least one rigid zone and several adjacent flexible or compressible zones in said strip and are defined by a period, measured lengthwise, which varies along said strip from a lower value in said at least one rigid zone to a greater value in each of said flexible or compressible zones, said at least one plastic carrier (being formed by at least two simultaneously co-extruded undulated lines which are joined together, so that said strip has a neutral bending axis whose position varies along it from a central position in the median plane of said base to an off center position adjacent one of said arms, said off center position being configured to assist the curvature of at least one of said flexible zones of said strip towards the outside of this adjacent arm.

7. The sealing strip according to claim 6, wherein said at least one plastic carrier is formed by two substantially identical undulated lines) which have each a lateral series of peaks along one of said arms and a central series of peaks along said base, the central series of peaks of both lines being joined together in a junction along said base:
either peak to peak to form in this junction said neutral bending axis, both lines forming in a top view a succession of rhombs or hexagons,
or in such a way that the peaks of both central series of lines respectively overlap each other so as to form a succession of stretched figures along said base, which are interspersed in alternation with another succession of lanced figures respectively formed by the pairs of facing peaks of both lateral series.

8. The sealing strip according to claim 4, wherein said at least one plastic carrier is formed by one undulated line to which is joined at least one straight line extending along the longitudinal direction of said base.

9. The sealing strip according to claim 3, wherein it forms a glass run channel for a side window configured to be mounted on a door frame, or a door seal configured to be mounted on a bodywork of the motor vehicle.

10. The sealing strip according to claim 1, wherein it forms an inner belt for a side window comprising said two compressible zones at both ends of said rigid zone, both compressible zones improving the acoustic performance of the inner belt.

11. The sealing strip according to claim 1, wherein said at least one plastic carrier is based on at least one extrusible thermoplastic polymer, said flexible polymeric cover being based on at least one co-extrusible elastomer.

12. Method for manufacturing an extruded sealing strip for a motor vehicle designed to be clamped upon a frame, said strip comprising at least one extruded reinforcing plastic carrier around which a flexible polymeric cover is co-extruded, wherein it comprises:
a) extruding a blank for said at least one carrier in the shape of at least one two-dimensional undulated line which has alternating undulations extending in an extrusion direction, through at least one oscillating die plate which reciprocates back and forth in a direction perpendicular to said extrusion direction and according to a reciprocating speed which varies at given time intervals in relation to the linear extrusion speed, in such a manner that the undulations pattern of said at least one extruded carrier blank varies along the length thereof,
b) co-extruding said cover which is based on at least one co-extrusible thermoplastic elastomer (TPE), either simultaneously or subsequently onto and around said at least one extruded carrier blank, so as to obtain a co-extruded strip blank,
c) calibrating this co-extruded strip blank in calibrating or sizing plates or blocks, so as to give it its desired final three-dimensional configuration, such as in a substantially U, C, V, S or W-shaped cross-section, and
d) cooling the strip obtained in step c) so that it keeps its final configuration, the undulations pattern created in step a) imparting more or less flexibility to the sealing strip along its length.

13. Method according to claim 12, wherein step a) comprises varying said reciprocating speed in relation to said linear extrusion speed in such a manner that said undulations form at least one rigid zone and several adjacent flexible or compressible zones, in said strip, and are defined by a period, measured lengthwise, which varies along said strip from a lower value in said at least one rigid zone to a greater value in each of said flexible or compressible zones.

14. Method according to claim 13, wherein said at least one rigid zone formed in step a) is substantially straight, whereas each of said flexible or compressible zones also formed in step a) is curveable in step c) according to a determined radius of curvature of a corresponding curved portion of said frame.

15. Method according to claim 13, wherein said at least one carrier blank obtained in step a) is formed by:
one undulated line which has two lateral series of end peaks respectively extending lengthwise in alternation, or by
at least two undulated lines which are simultaneously co-extruded and joined together, so that said strip obtained in step d) has a neutral bending axis whose position varies along it from a central position in the median plane of said blank to an off center position with respect to that median plane, said off center position assisting the curvature of at least one curved flexible zone towards the adjacent lateral end of the strip.

16. Method according to claim 12, wherein step a) is carried out by means of programmable stepper motors, to make said at least one die plate oscillate according to a reciprocating speed which is controlled with respect to said variable linear extrusion speed.

17. Method according to claim 12, wherein step b) is carried out by means of at least one additional extrusion die for the subsequent co-extrusion of said flexible cover.

18. A device for manufacturing an extruded sealing strip for a motor vehicle or building configured to be clamped upon a frame, said strip comprising at least one extruded reinforcing plastic carrier around which a flexible polymeric cover is co-extruded, wherein it comprises:
a co-extrusion unit for co-extruding said cover onto and around said at least one carrier, which is in the shape of at least one two-dimensional undulated line which has undulations extending in an extrusion direction, said co-extrusion unit comprising:
at least one oscillating die plate which is configured to extrude said at least one carrier and which is able to reciprocate back and forth in a direction perpendicular to said extrusion direction, so as to form said undulations with a pattern which varies along the length of said carrier,
control means comprising programmable stepper motors, and which are designed to make said at least one die plate oscillate according to a controlled reciprocating speed which is variable with respect to an also controlled linear extrusion speed for said at least one carrier, and
at least one additional extrusion die for the co-extrusion of said cover onto and around said a least one carrier so as to obtain a two-dimensional sealing strip blank;
calibration or sizing plates or blocks for calibrating the co-extruded strip blank, to give it its desired final three-dimensional configuration, such as in a substantially U, C, V, S or W-shaped cross-section; and
cooling means for cooling the calibrated strip so that it keeps its final configuration.
